(19) United States
(12) Patent Application Publication
(10) Pub. No.: US 2015/0107402 A1
(43) Pub. Date: Apr. 23, 2015

(54) ADJUSTABLE PEDAL ASSEMBLY WITH HYSTERESIS

(71) Applicant: KSR IP Holdings, LLC, Ridgetown (CA)

(72) Inventor: Daniel Leem, Chatham (CA)

(21) Appl. No.: 14/518,369

(22) Filed: Oct. 20, 2014

Related U.S. Application Data
(60) Provisional application No. 61/892,634, filed on Oct. 18, 2013.

(51) Int. Cl. G05G 1/40; G05G 1/44

(52) U.S. Cl. CPC G05G 1/40; G05G 1/44
USPC 74/512

(57) ABSTRACT

An adjustable pedal assembly for use in a vehicle is provided having, a housing having a main pivot point, a pedal arm pivotally connected to the main pivot point of the housing, an actuator connected to the pedal arm, the actuator adapted to adjust the positioning of the pedal arm with respect to the main pivot point and a hysteresis mechanism connected to the pedal arm, the hysteresis mechanism adapted to provide feedback to the user of the pedal when the pedal assembly is depresses wherein resistance is increased as the pedal is depressed further.

### CROSS-REFERENCE TO RELATED APPLICATIONS

This utility patent application claims priority from U.S. provisional patent application Ser. No. 61/892,634, filed Oct. 18, 2013, the entire contents of which is incorporated herein in its entirety.

### FIELD OF THE INVENTION

The present invention relates to pedals, more particularly to an adjustable vehicle pedal assembly having hysteresis.

### BACKGROUND OF THE INVENTION

Adjustable pedal assemblies for adjusting the position of a pedal arm to accommodate a driver of a vehicle are well known in the prior art. These adjustable pedal assemblies are typically conventional pedal assemblies providing for adjustability of the pedal arm independent of the main pivot point. Examples of these adjustable pedal assemblies are illustrated in commonly owned U.S. Pat. Nos. 6,584,871; 6,862,950; 7,114,411; 6,918,318; 5,771,752; 6,389,972; and 6,178,847. None of the known prior art, however, provides for an adjustable pedal assembly also providing for hysteresis, or feedback felt by the driver of the vehicle. This hysteresis feedback is especially important for brake-by-wire systems where the traditional brake rod is not used. Further, providing hysteresis in conventional braking systems provides additional feedback to the driver of the vehicle when braking. As such, there exists a need in the art to provide an adjustable pedal assembly also having a hysteresis feature.

### SUMMARY OF THE INVENTION

An adjustable pedal assembly for use in a vehicle is provided having, a housing having a main pivot point, a pedal arm pivotally connected to the main pivot point of the housing, an actuator connected to the pedal arm, the actuator adapted to adjust the positioning of the pedal arm with respect to the main pivot point and a hysteresis mechanism connected to the pedal arm, the hysteresis mechanism adapted to provide feedback to the user of the pedal when the pedal assembly is depresses wherein resistance is increased as the pedal is depressed further.

In one embodiment, the pedal arm may include an upper portion and a lower portion where the upper portion is pivotally connected to the lower portion, the upper portion pivotally connected to the main pivot point. The upper portion of the pedal arm is stationary. Further, an upper link and a lower link are provided directly connected to the actuator, the upper link and the lower link both pivotally connected to the pedal arm and adapted to adjust the pedal arm. The hysteresis mechanism is a spring or damper having a cam roller, the cam roller connected a cam surface, the cam roller adapted to roll on the cam surface to provide feedback to the user.

In a second embodiment, an A-frame bracket connects the pedal arm to the actuator, the A-frame bracket supporting the actuator. In this embodiment, the actuator is spaced apart from the pedal arm.

In the first embodiment, the pedal assembly includes a main pivot point, a pedal arm having an upper portion pivotally connected to a lower portion, the upper portion of the pedal arm pivotally connected to the main pivot point, an upper link and a lower link pivotally interconnected, the upper link connected to the upper portion of the pedal arm, the lower link pivotally connected to the lower portion of the pedal arm wherein the upper portion of the pedal arm being stationary, the lower portion of the pedal arm, the upper link and the lower link each movable with respect to the stationary upper portion of the pedal arm by means of an actuator connected to the upper link and the lower link, the actuator adapted to move the upper link, the lower link and the lower portion of the pedal arm thereby adjusting the lower portion of the pedal arm.

A hysteresis generating mechanism is connected to the pedal assembly to provide feedback to the driver. The hysteresis generating mechanism is a spring or damper having a cam roller, the cam roller connected a cam surface, the cam roller adapted to roll on the cam surface to provide feedback to the user. An actuator is provided connected to the upper link and the lower link, the actuator in communication with the pedal arm, the actuator adapted to adjust the positioning of the lower portion of the pedal min with respect to the stationary upper portion of the pedal arm. The cam is spaced apart from the pedal arm.

In the second embodiment, the pedal arm includes a housing having a main pivot point, a pedal arm pivotally connected to the housing, an A-frame bracket connected to the housing, the pedal arm positioned to pivot within the A-frame bracket, an actuator connected to the A-frame bracket and the pedal arm, the actuator adapted to adjust the positioning of the pedal arm with respect to the main pivot point and a hysteresis generating mechanism connected to the pedal arm, the hysteresis generating mechanism having a spring or damper, the hysteresis generating mechanism having a cam roller, the cam roller connected a cam surface, the cam roller adapted to roll on the cam surface to provide feedback to the user. The pedal arm is adjustable up to 100 millimeters. The actuator is spaced apart from the pedal arm.

### BRIEF DESCRIPTION OF THE DRAWINGS

FIG. 1 illustrates a perspective view of an A-frame pedal assembly having a spring, cam roller, and cam;

FIG. 2 illustrates a side view of an A-frame pedal assembly having a spring, cam roller, and cam;

FIG. 3 illustrates perspective view of the multi-link adjustable pedal assembly having a hysteresis device;

FIG. 4 illustrates side view of the multi-link adjustable pedal assembly having a hysteresis device; and

FIG. 5 illustrates a cross sectional view of the multi-link adjustable pedal assembly.

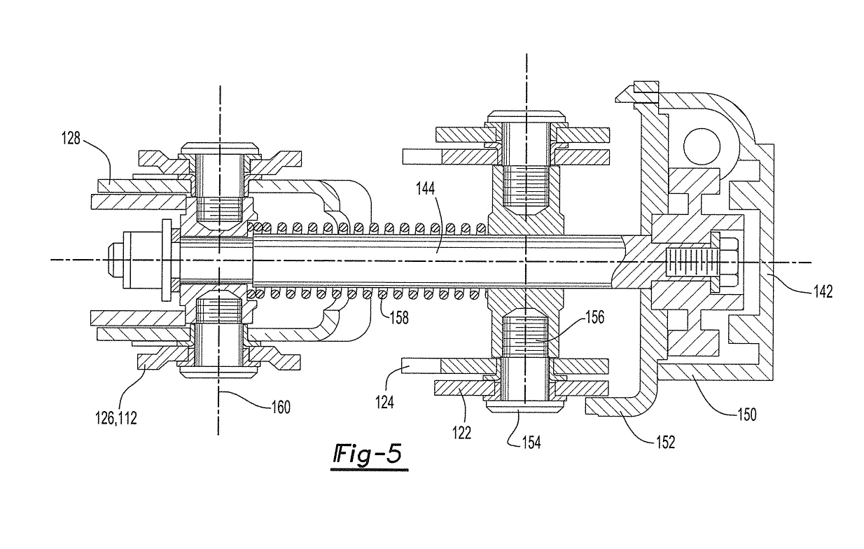

### DETAILED DESCRIPTION OF THE INVENTION

The present invention provides for an adjustable pedal assembly further including a hysteresis generating mechanism to provide increased feedback to the driver of the vehicle when the brake pedal is depressed. The assembly includes an actuator for adjusting the pedal arm mounted to either an A-frame or a multi-link design. The actuator is operable to adjust the pedal arm according to the height of the driver of the vehicle. A spring assembly is mounted to the lower portion of the pedal arm and includes a roller at an upper end. A cam having a cam surface is provided connected to the pedal arm. The roller of the spring assembly connects to the cam surface of the cam and rolls along the cam surface of the cam to provide hysteresis when the user depresses the pedal. Feedback increases as the roller rolls along the more inclined surfaces of the cam surface.

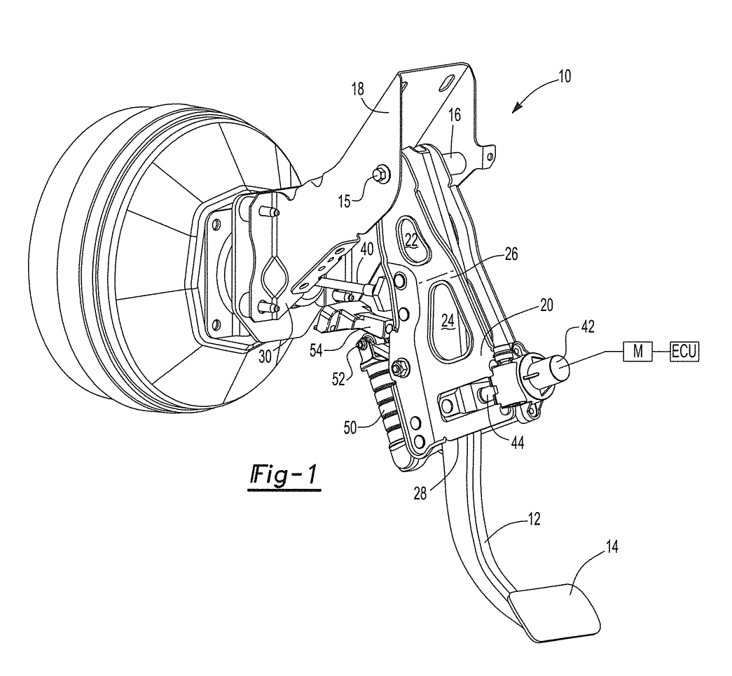

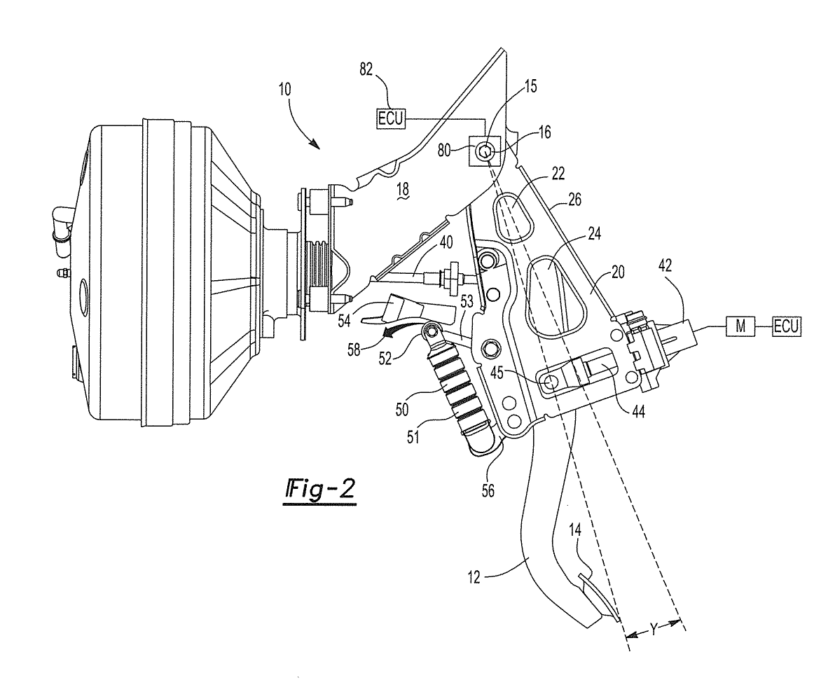

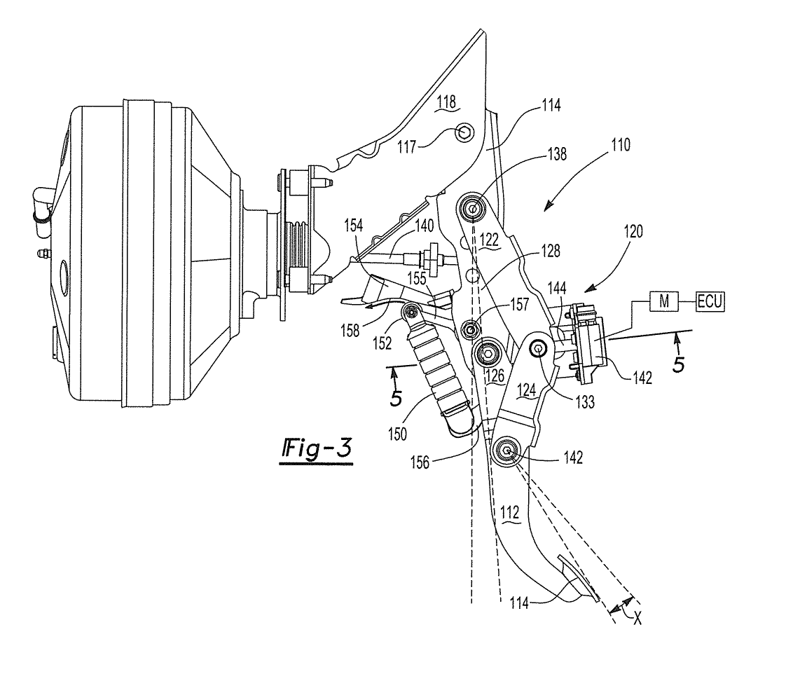

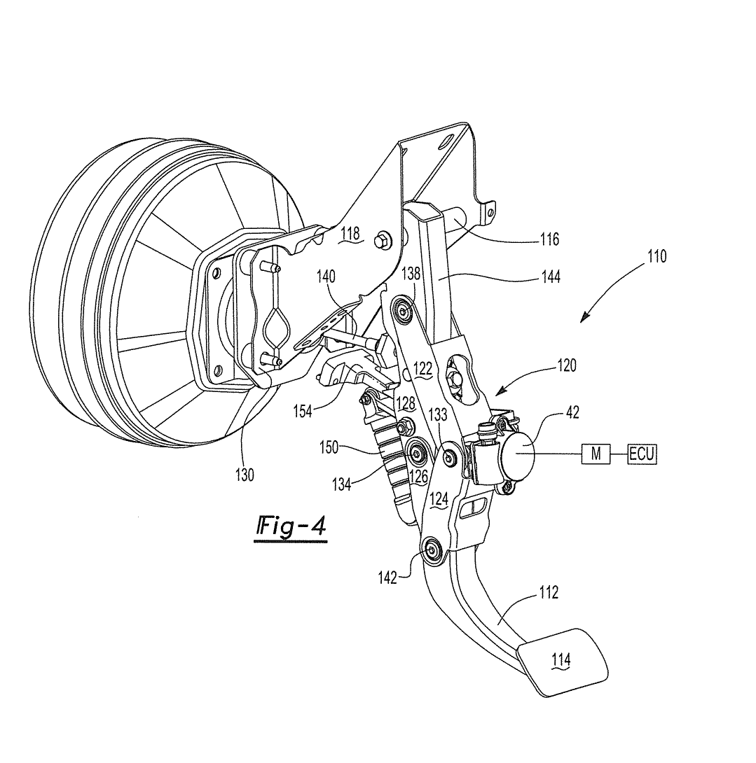

The “pedal assembly” is defined as either the multi-link assembly as shown in FIGS. 3 and 4 (alternative or second embodiment) or the A-frame assembly as shown in FIGS. 1 and 2 (first embodiment).

A first embodiment of an A-frame pedal assembly 10 having a pedal arm 12 and a pedal pad 14 is generally illustrated in FIGS. 1 and 2. The pedal arm 12 is mounted at an upper end of the pedal arm 12 at a pivot point 16, such as a rod or bolt. A nut 15 secures the pedal arm 12 to an upper housing 18. The upper housing 18 connects to the vehicle by a plurality of brackets. The pedal arm 12 connects to a main pivot point on the housing of the assembly. The pedal arm 12 is adapted to pivot within the A-frame adjustment bracket 20. The pedal arm 12 is an elongated one piece assembly having a pedal pad 14 mounted at a distal end of the assembly.

An A-frame adjustment bracket 20 extends over and around the pedal arm 12. The adjustment bracket 20 connects to the main pivot point 16 at an upper end. The adjustment bracket 20 further includes apertures 22, 24 and side wall 26. The A-frame adjustment bracket 20 supports an actuator 42. The actuator 42 is provided connected to the lower end of the adjustment bracket 20. The actuator 42 includes a push rod 44 connected to the pedal arm 12. The actuator 42 rotates the push rod 44 to move the pedal arm 12 to an adjusted position.

Movement of the pedal arm 12 from a first position to a fully adjusted pedal location A is illustrated in FIG. 2. In the present embodiment, the pedal arm 12 is adjustable between 15 and 100 millimeters. This adjustment allows the driver of the vehicle to more easily reach the pedal based on the driver's height and length of legs. The actuator 42 may include a wire connecting to a separate motor and ECU for controlling movement of the push rod 44. The push rod connects to the pedal arm 12 at a position 45.

The pedal assembly 10 further includes a hysteresis generating assembly 50. The assembly 50 includes a spring 51 and a roller 52. The assembly 50 connects to the adjustment bracket 20 at a lower end by a bracket 56. The hysteresis assembly 50 connects to the adjustment bracket 20 at an upper end by means of a bracket 53. The bracket 53 is pivotally connected to the adjustment housing 20 and to the roller 52. A cam 54 having a curved cam surface 58 is further provided either connected to the vehicle or further connected to the pedal assembly 10. As the user depresses the pedal arm 12 of the assembly, a roller 52 contacts the cam surface 58 and travels along the cam surface 58 thereby making depression of the pedal arm 12 more difficult (providing more feedback) as the roller reaches the curved portions of the cam surface. Further, the spring 51 may be compressed as the user depresses the pedal arm 12.

The incorporation of a hysteresis generating assembly in an adjustable pedal assembly is not known in the prior art. The hysteresis generating assembly used in combination with an adjustable pedal, such as the present embodiment of the A-frame adjustment bracket assembly, may be used in a conventional brake pedal assembly, such as shown in the present invention by using the brake rod 40, or may be used in a brake-by-wire system where sensors are utilized to determine the amount of depression of the brake pedal assembly. In a brake-by-wire assembly, a sensor 80 is provided mounted to the main pivot point 16 of the pedal assembly. An electronic control unit 82 or other suitable computer is further connected to the sensor to determine the amount of depression of the pedal assembly. The hysteresis generating assembly 50 becomes more applicable in a brake-by-wire system to provide the conventional feel of a conventional pedal assembly to the user of a brake-by-wire system.

The multi-link embodiment as illustrated in FIGS. 3 and 4 incorporates a four bar linkage system for adjustment of a pedal arm 112. The multi-link assembly 110 includes the pedal arm 112 having a pedal pad 114. The multi-link assembly is connected to a main pivot point 116 housed within an upper housing 118. The multi-link assembly 120 includes a series of four bars or links to construct the pedal arm assembly. An upper link (or upper arm) 122 is provided connected to an upper bracket 144. The upper link 122 connects to the upper bracket 144 by means of a pivot point 138. A second pedal link (or lower link or lower arm) 124 is provided connected to the upper link 122 at a pivot point 133. Both the upper link 122 and the lower link 124 directly connect to an actuator 142 at the pivot point 133. The link system 120 further includes links (upper pedal arm) 128 and the upper pedal portion 126 connected to the main pedal arm 112. The lower link 124 connects to the main pedal arm (or lower pedal arm) 112 at a pivot point 142. The upper pedal arm 126 connects to the link portion 128 at a pivot point 134. The upper pedal arm is stationary.

The actuator 142 includes a yoke or push rod 144 having threading operable to move the links and adjust the pedal arm 112. The pedal arm is movable between a distance of 15 millimeters and 100 millimeters to accommodate the needs of the driver. This distance is illustrated at reference X in FIG. 3 and as reference Y in FIG. 2. Connecting portions 170, 172 may further be connected to the push rod 144 operable to hold and engage the links. The actuator 142 is provided connected to the first end 168 of the push rod 144. As the actuator rotates the push rod 144, the links 122, 124 pivot about the pivot point 133 to move the pedal arm 112 in either a forwards or backwards direction. The actuator 142 may be further connected to a motor M and an ECU for controlling movement of the push rod 144 of the actuator 142.

A hysteresis assembly 150 is provided connected to the link system 120 of the assembly 110. The hysteresis assembly 150 may contain either a damper or a spring to absorb depression of the pedal 112. The hysteresis assembly 150 is connected by means of a plurality of brackets 156 to the links of the link system 120. A pivot rod 155 connects the link 128 to a roller 152 at a free end of the hysteresis assembly 150. The rod 155 is pivotable at the roller 152 and at pivot point.

A cam 154 is provided having a cam surface 158. The roller 152 of the hysteresis mechanism 150 abuts the cam surface 158. As the user depresses the pedal 112, the roller 152 rolls along the curved surface of the cam surface 158. As the roller 152 reaches the inclined portion of the curved cam surface, depression of the pedal arm 112 becomes more difficult. Further, as the pedal arm 112 is depressed, a damper or spring contained within the hysteresis mechanism 150 may be depressed to provide feedback to the user 112 to simulate the feel of a conventional pedal assembly or to provide additional feedback in a conventional pedal assembly.

The cam surfaces 58, 158 may be modified to provide increased resistance felt by the driver of the vehicle. By way of example, the driver may feel minimal resistance as he first begins to depress the pedal, but resistance may increase as the driver depresses the pedal further. This resistance is customized by the curvature of the cam surfaces 58, 158.

An adjustable pedal assembly for use in a vehicle is provided having, a housing having a main pivot point, a pedal arm pivotally connected to the main pivot point of the housing, an actuator connected to the pedal arm, the actuator adapted to adjust the positioning of the pedal arm with respect to the main pivot point and a hysteresis mechanism connected to the pedal arm, the hysteresis mechanism adapted to provide feedback to the user of the pedal when the pedal assembly is depresses wherein resistance is increased as the pedal is depressed further.

In one embodiment, the pedal arm may include an upper portion and a lower portion where the upper portion is pivotally connected to the lower portion, the upper portion pivotally connected to the main pivot point. The upper portion of the pedal arm is stationary. Further, an upper link and a lower link are provided directly connected to the actuator, the upper link and the lower link both pivotally connected to the pedal arm and adapted to adjust the pedal arm. The hysteresis mechanism is a spring or damper having a cam roller, the cam roller connected a cam surface, the cam roller adapted to roll on the cam surface to provide feedback to the user.

In a second embodiment, an A-frame bracket connects the pedal arm to the actuator, the A-frame bracket supporting the actuator. In this embodiment, the actuator is spaced apart from the pedal arm.

In the first embodiment, the pedal assembly includes a main pivot point, a pedal arm having an upper portion pivotally connected to a lower portion, the upper portion of the pedal arm pivotally connected to the main pivot point, an upper link and a lower link pivotally interconnected, the upper link connected to the upper portion of the pedal arm, the lower link pivotally connected to the lower portion of the pedal arm wherein the upper portion of the pedal arm being stationary, the lower portion of the pedal arm, the upper link and the lower link each movable with respect to the stationary upper portion of the pedal arm by means of an actuator connected to the upper link and the lower link, the actuator adapted to move the upper link, the lower link and the lower portion of the pedal arm thereby adjusting the lower portion of the pedal arm. A hysteresis generating mechanism is connected to the pedal assembly to provide feedback to the driver. The hysteresis generating mechanism is a spring or damper having a cam roller, the cam roller connected a cam surface, the cam roller adapted to roll on the cam surface to provide feedback to the user. An actuator is provided connected to the upper link and the lower link, the actuator in communication with the pedal arm, the actuator adapted to adjust the positioning of the lower portion of the pedal arm with respect to the stationary upper portion of the pedal arm.

In the second embodiment, the pedal arm includes a housing having a main pivot point, a pedal arm pivotally connected to the housing, an A-frame bracket connected to the housing, the pedal arm positioned to pivot within the A-frame bracket, an actuator connected to the A-frame bracket and the pedal arm, the actuator adapted to adjust the positioning of the pedal arm with respect to the main pivot point and a hysteresis generating mechanism connected to the pedal arm, the hysteresis generating mechanism having a spring or damper, the hysteresis generating mechanism having a cam roller, the cam roller connected a cam surface, the cam roller adapted to roll on the cam surface to provide feedback to the user. The pedal arm is adjustable up to 100 millimeters. The actuator is spaced apart from the pedal arm.

In both embodiments, the cam is spaced apart from the pedal arm. The cam is connected either to the vehicle or to the housing. In the multi-link assembly as shown in FIGS. 3 and 4, the cam is connected to the upper link 122 by means of a connector extending through the upper pedal arm 128 (which is stationary).

The invention is not restricted to the illustrative examples and embodiments described above. The methods are not intended as limitations on the scope of the invention. Methods, apparatus, compositions, and the like described herein are exemplary and not intended as limitations on the scope of the invention. Changes therein and other uses will occur to those skilled in the art.

1. An adjustable pedal assembly for use in a vehicle, the pedal assembly comprising:
a housing having a main pivot point;
a pedal assembly pivotally connected to the main pivot point of the housing, the pedal assembly having a pedal arm;
an actuator connected to the pedal assembly, the actuator adapted to adjust the positioning of the pedal arm with respect to the main pivot point; and
a hysteresis mechanism connected to the pedal arm, the hysteresis mechanism connected to a cam, the cam spaced apart from the pedal arm, the hysteresis mechanism having a cam roller adapted to roll on the cam, the hysteresis mechanism adapted to provide feedback to the user of the pedal when the pedal assembly is depresses wherein resistance is increased as the pedal is depressed further.

2. The adjustable pedal assembly of claim 1 wherein the pedal assembly is a multi-link assembly.

3. The adjustable pedal assembly of claim 2 wherein the pedal arm includes an upper portion and a lower portion, the upper portion pivotally connected to the lower portion, the upper portion pivotally connected to the main pivot point.

4. The adjustable pedal assembly of claim 2 wherein the upper portion of the pedal arm is stationary.

5. The adjustable pedal assembly of claim 2 wherein an upper link and a lower link are provided directly connected to the actuator, the upper link and the lower link both pivotally connected to the pedal arm and adapted to adjust the pedal arm.

6. The adjustable pedal assembly of claim 1 wherein the hysteresis mechanism is a spring or damper having a cam roller, the cam roller connected a cam surface, the cam roller adapted to roll on the cam surface to provide feedback to the user.

7. The adjustable pedal assembly of claim 1 wherein the pedal assembly is an A-frame bracket that connects the pedal arm to the actuator, the A-frame bracket supporting the actuator.

8. The adjustable pedal assembly of claim 7 wherein the actuator is spaced apart from the pedal arm.

9. An adjustable pedal assembly for use in a vehicle, the pedal assembly comprising:
a main pivot point;
a pedal arm having an upper portion pivotally connected to a lower portion, the upper portion of the pedal arm pivotally connected to the main pivot point
an upper link and a lower link pivotally interconnected, the upper link connected to the upper portion of the pedal arm, the lower link pivotally connected to the lower portion of the pedal arm
the upper portion of the pedal arm being stationary, the lower portion of the pedal arm, the upper link and the lower link each movable with respect to the stationary upper portion of the pedal arm by means of an actuator connected to the upper link and the lower link, the actuator adapted to move the upper link, the lower link and the lower portion of the pedal arm thereby adjusting the lower portion of the pedal arm.

10. The adjustable pedal assembly of claim 9 wherein a hysteresis generating mechanism is connected to the pedal assembly to provide feedback to the driver.

11. The adjustable pedal assembly of claim 10 wherein the hysteresis generating mechanism is a spring or damper having a cam roller, the cam roller connected a cam surface, the cam roller adapted to roll on the cam surface to provide feedback to the user.

12. The adjustable pedal assembly of claim 10 wherein an actuator is provided connected to the upper link and the lower link, the actuator in communication with the pedal arm, the actuator adapted to adjust the positioning of the lower portion of the pedal arm with respect to the stationary upper portion of the pedal arm.

13. The adjustable pedal assembly of claim 11 wherein the cam is spaced apart from the pedal arm.

14. An adjustable pedal assembly comprising:
a housing having a main pivot point;
a pedal arm pivotally connected to the housing;
an A-frame bracket connected to the housing, the pedal arm positioned to pivot within the A-frame bracket;
an actuator connected to the A-frame bracket and the pedal arm, the actuator adapted to adjust the positioning of the pedal arm with respect to the main pivot point;
a hysteresis generating mechanism connected to the pedal arm, the hysteresis generating mechanism having a spring or damper, the hysteresis generating mechanism having a cam roller, the cam roller connected a cam surface, the cam roller adapted to roll on the cam surface to provide feedback to the user.

15. The adjustable pedal assembly of claim 14 wherein the pedal arm is adjustable up to 100 millimeters.

16. The adjustable pedal assembly of claim 14 wherein the cam is spaced apart to the pedal arm.

17. The adjustable pedal assembly of claim 14 wherein the actuator is spaced apart from the pedal arm.
